(19) United States
(12) Patent Application Publication
(10) Pub. No.: US 2026/0209016 A1
(43) Pub. Date: Jul. 23, 2026

(54) UNMANNED TRANSPORT VEHICLE

(71) Applicant: NAKANISHI METAL WORKS CO., LTD., Osaka-shi (JP)

(72) Inventors: Yutaro UENAKA, Osaka-shi (JP); Keisuke HASEGAWA, Osaka-shi (JP)

(73) Assignee: NAKANISHI METAL WORKS CO., LTD., Osaka-shi (JP)

(21) Appl. No.: 19/446,147

(22) Filed: Jan. 12, 2026

(30) Foreign Application Priority Data
Jan. 21, 2025 (JP) 2025-008212

(51) Int. Cl. B66F 9/075; B66F 9/06

(52) U.S. Cl. CPC B66F 9/0755; B66F 9/063

(57) ABSTRACT

An unmanned transport vehicle includes a positional misalignment detection unit that detects positional misalignment of the transport object relative to the unmanned transport vehicle either before the transport object is loaded on the unmanned transport vehicle or while the transport object is loaded on the unmanned transport vehicle and a movement control unit that controls movement of the unmanned transport vehicle. The positional misalignment detection unit detects presence/ absence of the positional misalignment by reflection or passing of at least two light beams emitted from the unmanned transport vehicle toward the transport object and traveling in parallel at an interval. The movement control unit controls a correction operation of the unmanned transport vehicle that is moved for correcting the positional misalignment when the positional misalignment detection unit detects the positional misalignment, and compares a movement amount of the unmanned transport vehicle during the correction operation with a threshold value.

### BACKGROUND OF THE INVENTION

### FIELD OF THE INVENTION

The present invention relates to an unmanned transport vehicle that travels autonomously along a predetermined route.

### DESCRIPTION OF THE BACKGROUND ART

There are known automated guided vehicles (AGV) that travel autonomously along predetermined routes (see Patent Literature (PTL) 1, for example). The AGV (mobile drive unit 20) of PTL 1 slides under a transport object (inventory holder 30) with a lifting table (docking head 110) in a lowered state, then moves to a designated location in a workspace with the lifting table raised to lift the transport object.

Various factors, such as vibration during transport of transport objects by the AGV and cumulative errors from repeated transport by the AGV, may cause a position of the transport object to be misaligned. In such cases, even if a stop position of the AGV is correct, a position of the transport object relative to the AGV is misaligned, requiring manual adjustment of the position of the transport object.

PTL 1 discloses that a difference between a predetermined position of the AGV (a position of a reference mark 50 detected by a position sensor 140) and a position of the transport object is checked, before the AGV (mobile drive unit 20) transports the transport object (inventory holder 30). If the difference is greater than or equal to a predetermined value, the difference is automatically corrected (paragraphs [0022], [0031], [0045], and [0054] of PTL1).

In PTL 1, the position of the transport object is recognized by a mark (holder identifier 360) provided on the transport object. The AGV detects the mark using a sensor (holder sensor 150) provided on the lifting table (docking head 110) and repositions itself so that the sensor is positioned beneath the mark.

### CITATION LIST

### PATENT LITERATURE

[PTL 1] Japanese Patent No. 5199251

### SUMMARY

### TECHNICAL PROBLEM

To correct the difference between a predetermined position of the AGV and a position of the transport object (misalignment of the transport object), it is necessary to recognize the position of the transport object. PTL 1 requires all transport objects to be marked with a holder identifier 360 for position recognition, resulting in increased labor steps. In particular, automated warehouses that receive incoming transport objects daily require an enormous amount of labor steps to mark each transport object.

An object of the present invention is to provide an unmanned transport vehicle capable of detecting positional misalignment of transport objects without requiring marks on the transport objects and correcting the positional misalignment.

### SOLUTION TO PROBLEM

An unmanned transport vehicle according to a first aspect of the present invention autonomously travels along a predetermined travel route to transport a transport object. The unmanned transport vehicle includes: a positional misalignment detection unit that detects positional misalignment of the transport object relative to the unmanned transport vehicle either before the transport object is loaded on the unmanned transport vehicle or while the transport object is loaded on the unmanned transport vehicle; and a movement control unit that controls movement of the unmanned transport vehicle. The positional misalignment detection unit detects presence or absence of the positional misalignment by reflection or passing of at least two light beams that are emitted from the unmanned transport vehicle toward the transport object and travel in parallel at a predetermined interval. The movement control unit controls a correction operation of the unmanned transport vehicle that is to be moved for correcting the positional misalignment when the positional misalignment detection unit detects the positional misalignment, and compares an amount of the movement of the unmanned transport vehicle during the correction operation with a threshold value.

In the unmanned transport vehicle according to the first aspect, the positional misalignment of the transport object relative to the unmanned transport vehicle is detected by reflection or passing of at least two light beams that are emitted from the positional misalignment detection unit provided in the unmanned transport vehicle and travel in parallel at a predetermined interval, either before the transport object is loaded on the unmanned transport vehicle or while the transport object is loaded on the unmanned transport vehicle. Therefore, it is possible to quickly detect the presence or absence of the positional misalignment of the transport object and a direction of the positional misalignment of the transport object without providing a mark on the transport object, and without incurring computational costs.

In the unmanned transport vehicle according to the first aspect, the movement control unit provided in the unmanned transport vehicle controls the correction operation of the unmanned transport vehicle that is to be moved for correcting the positional misalignment when the positional misalignment detection unit detects the positional misalignment, and compares an amount of the movement of the unmanned transport vehicle during the correction operation with a threshold value. As a result of the comparison by the movement control unit between the movement amount and the threshold value, the movement amount may be below the threshold value, for example. In such a case, the correction operation is performed to enable correction of the positional misalignment by the movement control unit, and prevents interference with external objects during the correction operation.

An unmanned transport vehicle according to a second aspect of the present invention further includes: a two-dimensional code reading sensor that reads a two-dimensional code provided on a ground. The two-dimensional code is read using the two-dimensional code reading sensor, thereby obtaining the amount of the movement.

In the unmanned transport vehicle according to the second aspect, the two-dimensional code is read using the two-dimensional code reading sensor, thereby obtaining the amount of the movement. Accordingly, the movement amount can be determined with high accuracy. Therefore, an effect of preventing the interference with external objects during the correction operation is enhanced.

In an unmanned transport vehicle according to a third aspect of the present invention, in the unmanned transport vehicle according to the first aspect, two of the light beams are emitted under a condition where (i) a movement direction along which the unmanned transport vehicle approaches a predetermined position at which the transport object is loaded is defined as a forward direction, (ii) the predetermined interval is an interval in a front-back direction, and (iii) the light beams are emitted in a leftward direction or a rightward direction. The positional misalignment detection unit determines that no positional misalignment exists when detecting reflection of both the two light beams emitted in the leftward direction or the rightward direction.

In an unmanned transport vehicle according to a fourth aspect of the present invention, in the unmanned transport vehicle according to the first aspect, two of the light beams are emitted under a condition where (i) a movement direction along which the unmanned transport vehicle approaches a predetermined position at which the transport object is loaded is defined as a forward direction, (ii) the predetermined interval is an interval in a front-back direction, and (iii) the light beams are emitted in an upward direction. The positional misalignment detection unit determines that no positional misalignment exists when detecting no reflection from either of the two light beams emitted in the upward direction.

The unmanned transport vehicles according to the third and fourth aspects of the present invention, the effects same as those obtained by the unmanned transport vehicle according to the first aspect are provided.

In an unmanned vehicle according to a fifth aspect of the present invention, in the unmanned vehicles according to the third and fourth aspects, when the positional misalignment detection unit determines that no positional misalignment exists, the movement control unit causes the unmanned transport vehicle to move in the front-back direction, stops the unmanned transport vehicle at a position where the positional misalignment detection unit has detected the positional misalignment, and detects a front end and a rear end of an entire or a part of the transport object, and uses a center position of the transport object in the front-back direction, to align the unmanned transport vehicle relative to the transport object, the center position being obtained from the front end detected and the rear end detected.

In an unmanned vehicle according to a sixth aspect of the present invention, in the unmanned vehicles according to the third and fourth aspects, when length of the transport object in the front-back direction is L, and an interval between the two light beams in the front-back direction is I, from a state where the positional misalignment detection unit determined that no positional misalignment exists, the movement control unit causes the unmanned transport vehicle to move in one of the forward direction and the backward direction, stops the unmanned transport vehicle at a position where the positional misalignment detection unit has detected the positional misalignment, and causes the unmanned transport vehicle to move in a remaining one of the forward direction and the backward direction by |L - I|/2.

The unmanned transport vehicles according to the fifth and sixth aspects enable more accurate positional alignment of the unmanned transport vehicle relative to the transport object in the front-back direction.

In an unmanned transport vehicle according to a seventh aspect, if the amount of the movement exceeds the threshold value, the movement control unit refrains from performing the correction operation, loads the transport object on the unmanned transport vehicle at a predetermined position where the unmanned transport vehicle loads the transport object, and causes the unmanned transport vehicle to move by a predetermined distance in an opposite direction to a movement direction of the unmanned transport vehicle for performing the correction operation, unloads the transport object from the unmanned transport vehicle, and performs the correction operation.

In the unmanned transport vehicle according to the seventh aspect, the movement control unit compares the movement amount of the transport vehicle during the correction operation with the threshold value. Even if the movement amount exceeds the threshold value, the correction operation can continue.

In an unmanned transport vehicle according to an eighth aspect, in the unmanned transport vehicle according to the first aspect, the light beams emitted from the unmanned transport vehicle toward the transport object are three or more in number, or two in number with a variable interval between the two light beams.

In the unmanned transport vehicle according to the eighth aspect, if the variation of a specified interval (front-back direction) in a surface of the transport object, which receives the light beams, is increased, a positional misalignment detection unit with the same configuration can address the variations.

In an unmanned transport vehicle according to a ninth aspect, in the unmanned transport vehicle according to the first or seventh aspect, the unmanned transport vehicle travels along a storage lane for the transport object and a path perpendicular to the storage lane, and refrains from entering the path when the correction operation is performed by the movement control unit.

In the unmanned transport vehicle according to the ninth aspect, the unmanned transport vehicle that travels along the storage lane for the transport object and a path perpendicular to the storage lane does not enter the path when the correction operation, thereby preventing interference with another transport vehicle traveling in the path.

### ADVANTAGEOUS EFFECTS

As described above, the present invention can provide an unmanned transport vehicle that can correct a positional misalignment by detecting the positional misalignment of a transport object without providing a mark on the transport object.

### BRIEF DESCRIPTION OF THE DRAWINGS

FIG. 1 is a perspective view of an unmanned transport vehicle according to an embodiment of the present invention.

FIG. 2 is a plan view of the unmanned transport vehicle shown in FIG. 1.

FIG. 3 is a bottom view of the unmanned transport vehicle shown in FIG. 1.

FIG. 4 is a perspective view with a partial cross-sectional view, showing a legged pallet that is a transport object to be transported by the unmanned transport vehicle shown in FIG. 1.

FIG. 5A is a plan view showing a state where the legged pallet is positioned without positional misalignment relative to the unmanned transport vehicle.

FIG. 5B is a plan view showing a state where the legged pallet is positionally misaligned in a backward direction.

FIG. 5C is a plan view showing a state where the legged pallet is positionally misaligned in a forward direction.

FIG. 6 is a plan view showing an example of the unmanned transport vehicle traveling along a storage lane for the legged pallet and a path perpendicular to the storage lane.

FIG. 7A is a rear view of the unmanned transport vehicle positioned in the storage lane shown in FIG. 6, showing that the unmanned transport vehicle with a lifting table lowered has slid beneath the legged pallet.

FIG. 7B is a rear view of the unmanned transport vehicle positioned in the storage lane shown in FIG. 6, showing the unmanned transport vehicle with the lifting table raised to lift the legged pallet for placing the legged pallet on receiving sections of the lifting table.

FIG. 8 is a perspective view of the unmanned transport vehicle according to an embodiment of the present invention.

FIG. 9 is a plan view of the unmanned transport vehicle shown in FIG. 8.

FIG. 10 is a perspective view of a flat pallet that is the transport object to be transported by the unmanned transport vehicle shown in FIG. 8.

FIG. 11A is a plan view showing a state where the flat pallet is positioned without positional misalignment relative to the unmanned transport vehicle.

FIG. 11B is a plan view showing a state where the flat pallet is positionally misaligned in the backward direction.

FIG. 11C is a plan view showing a state where the flat pallet is positionally misaligned in the forward direction.

FIG. 12A is a schematic front view showing an example of a correction operation of the unmanned transport vehicle using a movement control unit, showing a case where length of the transport object in a front-back direction is greater than a distance between two light beams in the front-back direction.

FIG. 12B is schematic front view showing an example of the correction operation of the unmanned transport vehicle using the movement control unit, showing a case where the length of the transport object in the front-back direction is shorter than the distance between the two light beams in the front-back direction.

FIG. 13A is a schematic front view showing an example where each leg of the legged pallet is thick, in a modified example using three light beams.

FIG. 13B is a schematic front view showing an example where each leg of the legged pallet is thin, in the modified example using the three light beams.

FIG. 14 is a schematic plan view showing an example of detecting misalignment of a transport object in a rotational direction.

### DESCRIPTION OF THE PREFERRED EMBODIMENTS

Hereinafter, embodiments of the present invention will be described with reference to the accompanying drawings.

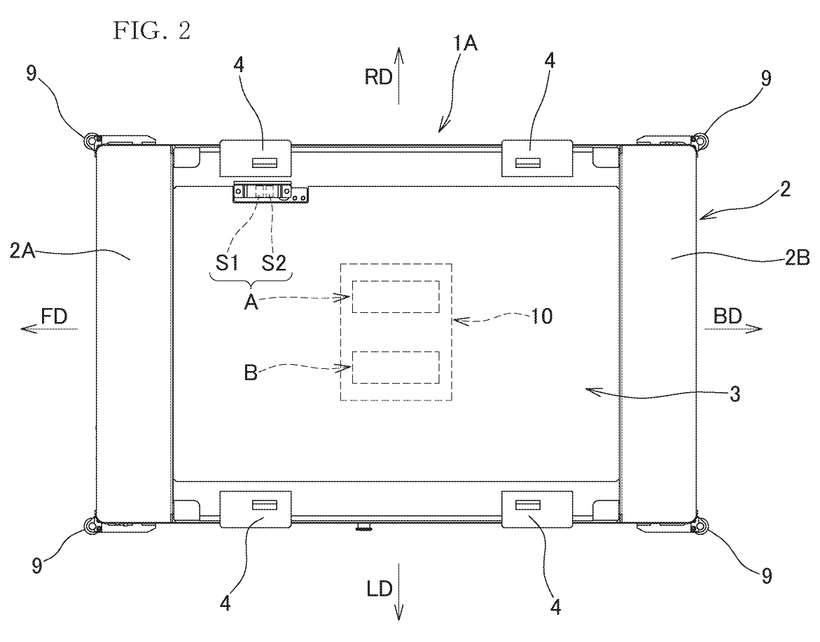

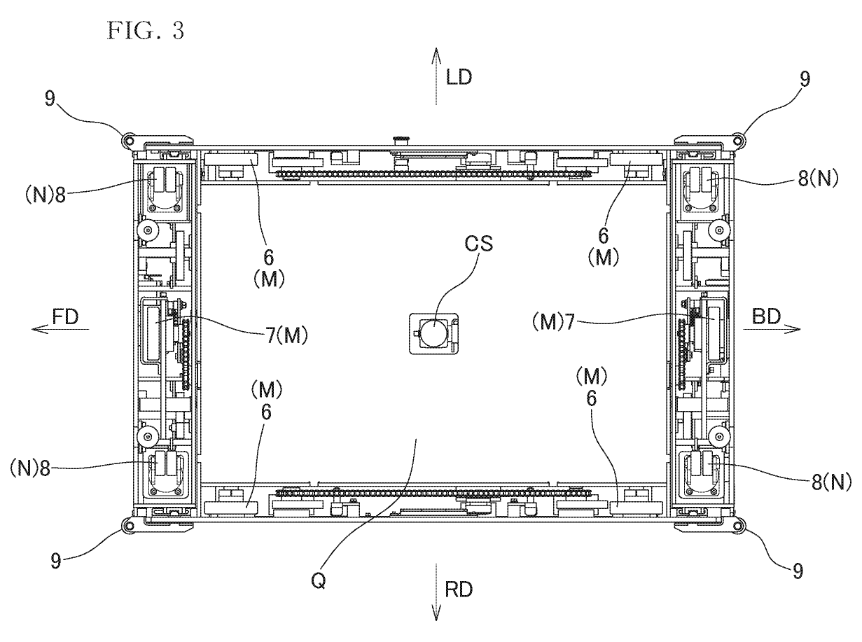

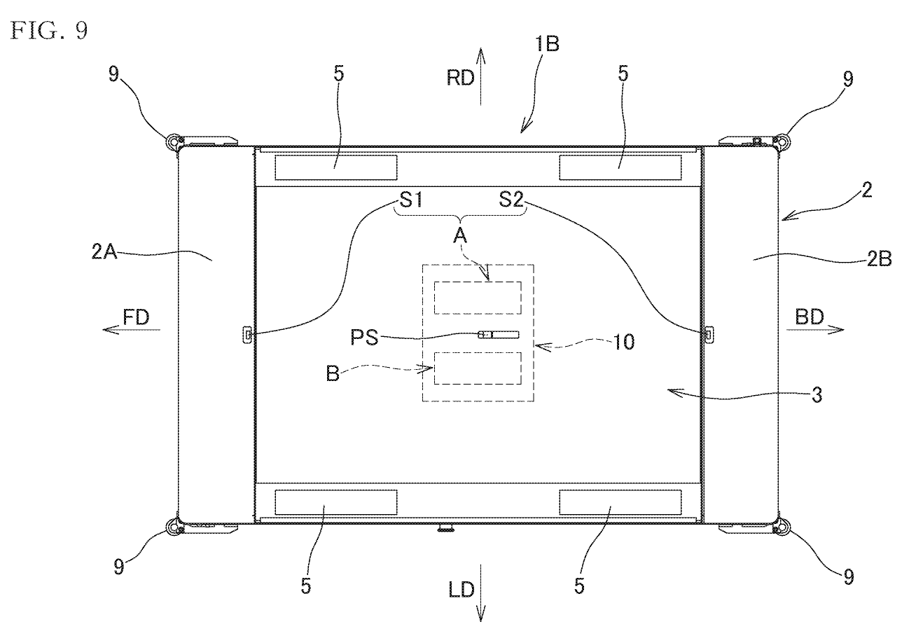

In the embodiments of the present invention, front, back, left, and right are defined relative to the orientation of transport vehicles 1A and 1B, for convenience. Specifically, arrows FD, BD, LD, and RD in the drawings indicate a forward direction, backward direction, left direction, and right direction, respectively. In the embodiments of the present invention, a view showing the transport vehicles 1A and 1B from the left direction LD is a front view. Thus, FIGS. 2 and 9 are plan views, and FIG. 3 is a bottom view.

### Example of unmanned transport vehicle and transport object

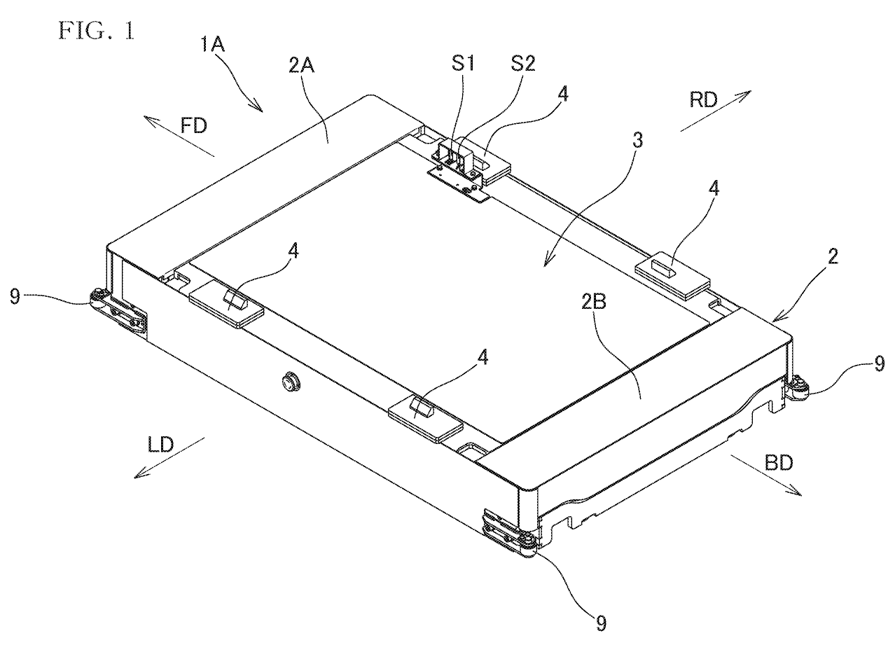

The transport vehicle 1A according to an embodiment of the present invention, which is shown in FIGS. 1 to 3, is an unmanned transport vehicle that autonomously travels along a predetermined path to transport a transport object. The transport vehicle 1A includes a vehicle body 2 with a substantially rectangular shape in a plan view, a lifting table 3, first traveling wheels 6 with axles oriented in a left-right direction, second traveling wheels 7 and 8 with axles oriented in the front-back direction, horizontal guide rollers 9 protruding from corners of the vehicle body 2, a control device 10, and the like.

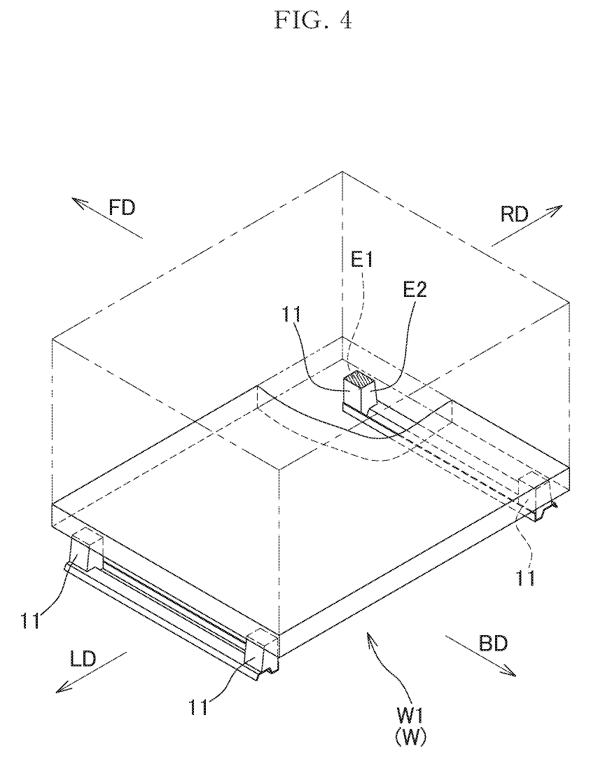

The lifting table 3 shown in FIGS. 1 and 2 is driven by a lifting drive device to move up and down, and a legged pallet W1 that is a transport object W and is shown in FIG. 4 is placed on receiving sections 4. The first traveling wheels 6 and the second traveling wheels 7 shown in FIG. 3 are driving wheels M that rotate when driven by a traveling drive device, while the second traveling wheels 8 are driven wheels N that function as swivel wheels.

The transport vehicle 1A is provided with a traveling wheel switch mechanism driven by a traveling wheel switch mechanism drive device. The traveling wheel switch mechanism switches states between a first travel state and a second travel state. In the first travel state, the first traveling wheels 6 shown in FIG. 3 are grounded on a travel surface and the second traveling wheels 7 and 8 are lifted off from the travel surface. In the second travel state, the second traveling wheels 7 and 8 shown in FIG. 3 are grounded on the travel surface and the first traveling wheels 6 are lifted off from the travel surface.

The control device 10 shown in FIG. 2 controls the lifting drive device, the traveling drive device, the traveling wheel switching mechanism drive device, and the like. The control device 10 includes a positional misalignment detection unit A that detects positional misalignment of a pallet W1 relative to the transport vehicle 1A either before loading the pallet W1 on the transport vehicle 1A or while the pallet W1 is being loaded on the transport vehicle 1A, and a movement control unit B that controls movement of the transport vehicle 1A.

In FIG. 2, the transport vehicle 1A travels in the forward direction FD or the backward direction BD in the first travel state, and travels in the left direction LD or the right direction RD in the second travel state. In the second travel state, when the two second traveling wheels 7, which are positioned centrally in the left-right direction and are the drive wheels M shown in FIG. 3, are rotated in the same direction but at different speeds, the transport vehicle 1A travels in the left direction LD or the right direction RD while changing its orientation in the forward direction FD or the backward direction BD. When the two front and rear second driving wheels 7 are rotated in opposite directions at the same speed, the transport vehicle 1A rotates in place.

The transport vehicle 1A is guided and controlled using a guidance unit. However, there are instances where the transport vehicle 1A is not guided and controlled when autonomously travels. For example, when the transport vehicle 1A travels along a travel rail while guided by a horizontal guide rail in the storage lane of an automated warehouse and the like, the transport vehicle 1A is not guided.

For the guidance unit, guide wires are used, for example. The guide wires include: a magnetic induction type such as a magnetic tape provided on the ground; an electromagnetic induction type utilizing induced current from a power line; and an optical induction type using an optical tape or a drawn line. Alternatively, an autonomous guidance may be employed instead of the guide wire. The autonomous guidance includes a simultaneous localization and mapping (SLAM), which determines a shape of the surrounding environment from information obtained by various sensors, estimates a position of the transport vehicle 1A itself based on data of the shape, and moves while creating a map through continuous correction.

When the magnetic tape is used as the guidance unit, a magnetic sensor provided in the transport vehicle 1A detects the magnetic tape. The movement control unit B of the control device 10 shown in FIG. 2 then controls movement of the transport vehicle 1A, causing the transport vehicle 1A to travel along the center of the magnetic tape.

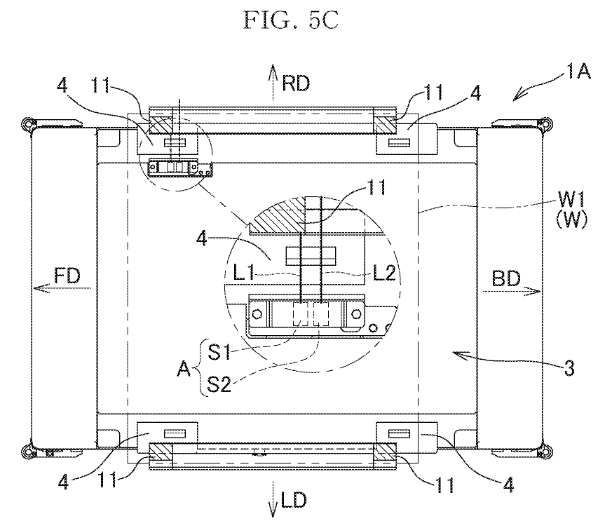

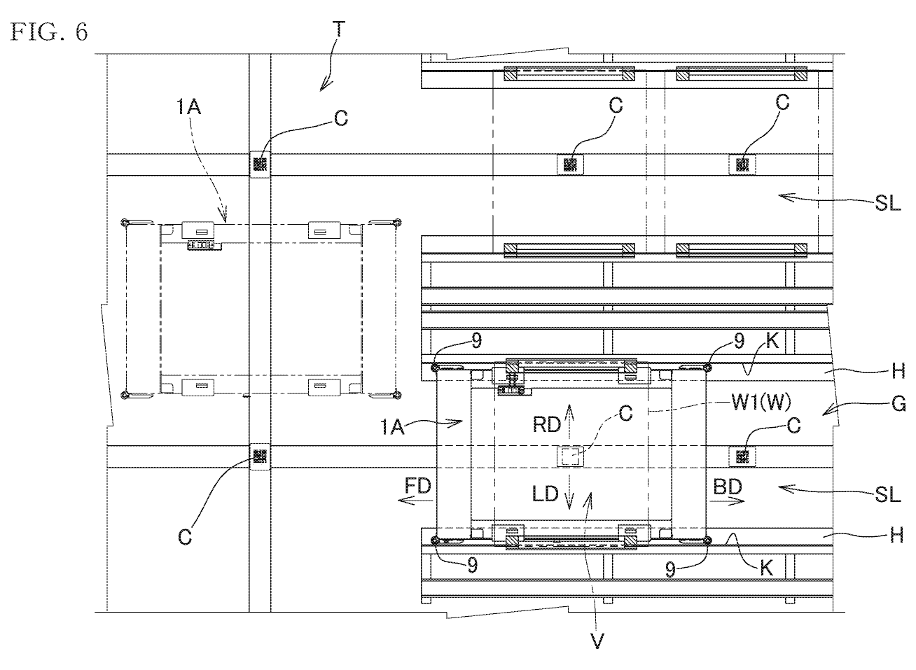

As shown in FIG. 3, the transport vehicle 1A is provided with a two-dimensional code reading sensor CS at a center portion of a bottom surface Q of the vehicle body 2. The two-dimensional code reading sensor CS is, for example, a two-dimensional vision sensor, and recognizes two-dimensional codes C provided on a ground side G, as shown in FIG. 6, for example.

Based on recognition information obtained by the two-dimensional code reading sensor CS, the movement control unit B controls the movement of the transport vehicle 1A to cause the transport vehicle 1A to stop at a target stop position, while measuring a distance to the two-dimensional code C in a traveling direction, for example.

Alternatively, the movement control unit B obtains coordinate data of the transport vehicle 1A from the information read from the two-dimensional codes C by the two-dimensional code reading sensor CS. Based on the coordinate data, coordinate data for the target stop position of another two-dimensional code C is set. The transport vehicle 1A stops when the two-dimensional code reading sensor CS reads the coordinate data for the target stop position. Accuracy in the stop of the transport vehicle 1A relative to the target stop position of the two-dimensional code C falls, for example, within ±3 mm.

### Detection of positional misalignment of pallet by positional misalignment detection unit

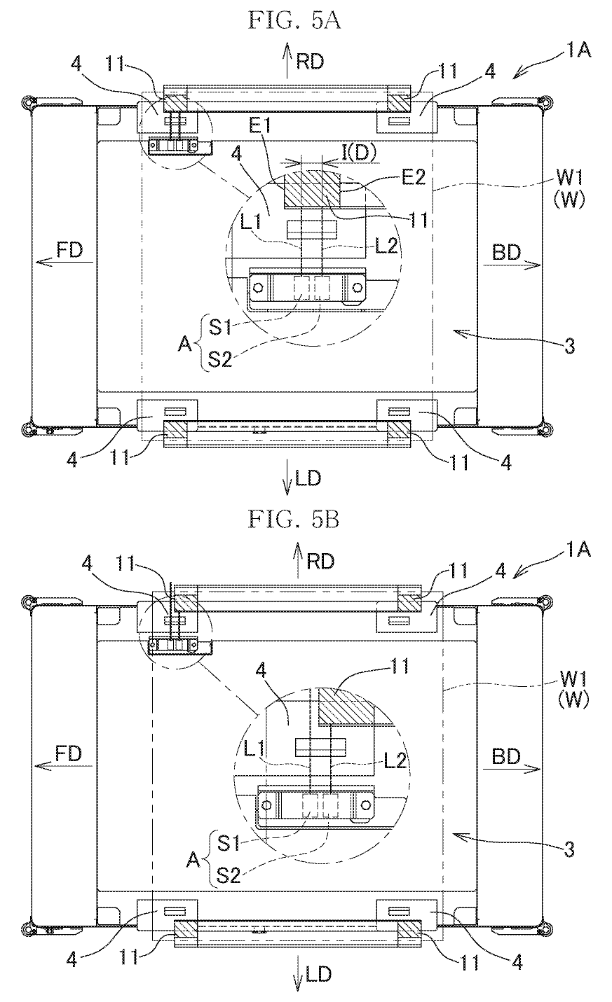

As shown in FIGS. 2 and 5A to 5C, the positional misalignment detection unit A, which detects positional misalignment of the pallet W1 relative to the transport vehicle 1A, includes a processing unit in the control device 10 and the pallet positional misalignment detection sensors S1, S2 provided in the vicinity of one of the receiving sections 4 that receives the lifting table 3.

The sensors S1 and S2 are reflective sensors that determine distance, for example. The sensors S1 and S2 emit light beams L1 and L2 from light emitting elements and can determine the distance to a measurement target object based on light positions of reflected light from the measurement target object, on the light-receiving elements. Therefore, stable detection of the measurement target object is possible.

In the present embodiment, as shown in FIGS. 5A to 5C, the positional misalignment detection unit A detects whether the pallet W1 is positionally misaligned based on presence or absence of reflection of the two light beams L1 and L2 (specifically, whether reflection occurs within a predetermined distance range).

The light beam L1 is emitted from the sensor S1 toward the pallet W1 in the right direction RD. The light beam L2 is emitted from the sensor S2 positioned in a rear side of the sensor S1, which is a backward direction BD side of the sensor S1, toward the pallet W1 in the right direction RD.

The two light beams L1 and L2 may be emitted toward the palette W1 in the left direction LD. The light beams L1 and L2 move in parallel at a predetermined interval D (interval I in the front-back direction), as shown in FIG. 5A, for example.

As shown in FIG. 5A, if the pallet W1 is not positionally misaligned relative to the transport vehicle 1A, the light beams L1 and L2 are reflected on the legs 11 of the pallet W1 (both sensors S1 and S2 detect the reflection within a predetermined distance range).

As shown in FIG. 5B, if the pallet W1 is positionally misaligned in the backward direction BD relative to the transport vehicle 1A, the light beam L1 travels through a front side of the leg 11, which is a forward direction FD side of the lift table 3, without reflecting on the leg 11, while the light beam L2 reflects on the leg 11 (the sensor S1 does not detect the reflection within the predetermined distance range, while the sensor S2 detects the reflection within the predetermined distance range).

As shown in FIG. 5C, if the pallet W1 is positionally misaligned in the forward direction FD relative to the transport vehicle 1A, the light beam L1 reflects off the leg 11, while the light beam L2 travels through a rear side of the leg 11, which is the backward direction BD side of the leg 11, without reflecting off the leg 11 (the sensor S1 detects the reflection within the predetermined distance range, while the sensor S2 does not detect the reflection within the predetermined distance range).

Thus, when either of the pallet misalignment detection sensors S1 and S2 fails to detect the reflection within the predetermined distance range, the positional misalignment detection unit A determines that the pallet W1 is misaligned relative to the transport vehicle 1A. Furthermore, even when neither of the pallet misalignment detection sensors S1 and S2 detect the reflection within the predetermined distance range, it can be determined that the pallet W1 is positionally misaligned relative to the transport vehicle 1A.

### Correction of positional misalignment of pallet by movement control unit

The movement control unit B controls a correction operation of the transport vehicle 1A that is moved for correcting the positional misalignment of the pallet W1 when the positional misalignment detection unit A detects positional misalignment of the pallet W1.

In a case shown in FIG. 5B (the sensor S1 does not detect the reflection within the predetermined distance range, while the sensor S2 detects the reflection within the predetermined distance range), the pallet W1 is positionally misaligned in the backward direction BD relative to the transport vehicle 1A. Therefore, a direction in which the movement control unit B causes the transport vehicle 1A to move is the backward direction BD.

In a case shown in FIG. 5C (the sensor S1 detects the reflection within the predetermined distance range, while the sensor S2 does not detect the reflection within the predetermined distance range), the pallet W1 is positionally misaligned in the forward direction FD relative to the transport vehicle 1A. Therefore, the direction in which the movement control unit B causes the transport vehicle 1A to move is the forward direction FD.

When performing the correction operation, the movement control unit B compares a movement amount of the transport vehicle 1A during the correction operation with a threshold value.

As a result of the comparison by the movement control unit B between the movement amount and the threshold value, the movement amount may be below the threshold value, for example. In such a case, the correction operation enables correction of the positional misalignment of the pallet W1 relative to the transport vehicle 1A by the movement control unit B, and prevents interference with external objects during the correction operation.

The movement amount of the transport vehicle 1A can be determined by reading the two-dimensional codes C provided on the ground side G as shown in FIG. 6 using the two-dimensional code reading sensor CS shown in FIG. 3. The movement amount can also be determined by an encoder installed on a rotation shaft or another component of a motor that drives the first traveling wheels 6, which are the driving wheels M.

According to the configuration in which the two-dimensional codes C provided on the ground side G are read by the two-dimensional code reading sensor CS provided on the transport vehicle 1A to determine the movement amount of the transport vehicle 1A during the correction operation, the movement amount can be determined with high accuracy. Therefore, an effect of preventing the interference with external objects during the correction operation is enhanced.

### Example of unmanned transport vehicle traveling along storage lane and path

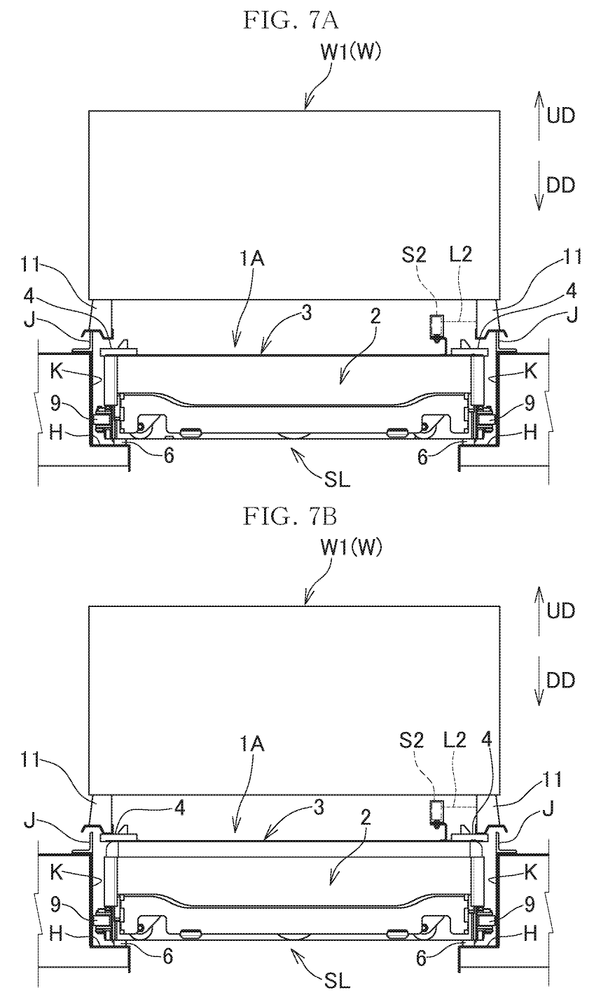

The transport vehicle 1A shown in FIG. 6 travels along a storage lane SL for storing the pallet W1 and a path T perpendicular to the storage lane SL. As shown in FIGS. 6 to 7B, in the storage lane SL, the transport vehicle 1A travels on left and right travel rails H extending in the front-back direction. In the storage lane SL, the horizontal guide rollers 9 of the transport vehicle 1A are guided by guidance surfaces K, thereby restricting misalignment of the transport vehicle 1A in the left-right direction.

As shown in FIG. 7A, the pallet W1 stored in the storage lane SL has the legs 11 that rest on placement sections J. The transport vehicle 1A can slide under the pallet W1 at a predetermined position in a downward direction DD with the lifting table 3 moved downward, as shown in FIG. 7A. As shown in FIG. 7B, the lifting table 3 is lifted to move the pallet W1 upward and to place the pallet W1 on the receiving sections 4.

In FIG. 6, when the positional misalignment detection unit A positioned beneath the pallet W1 at a leading position V detects the positional misalignment of the pallet W1, the movement control unit B performs the correction operation on the transport vehicle 1A to compensate for the positional misalignment.

When performing the correction operation, the movement control unit B compares the movement amount of the transport vehicle 1A during the correction operation with the threshold value. When the movement amount is at or below the threshold value, for example, the movement control unit B performs the correction operation while preventing the transport vehicle 1A from entering the path T during the correction operation. Since the transport vehicle 1A does not enter the path T during the correction action, interference with another transport vehicle 1A traveling in the path T can be prevented.

### Example where present invention is particularly effective

For example, in the storage lane SL shown in FIG. 6, the transport object W is repeatedly transported by the unmanned transport vehicle, increasing the number of times the unmanned transport vehicle comes into contact with the transport object W. As the number of times the unmanned transport vehicle contacts the transport object W increases, the positional misalignment of the transport object W relative to the vehicle’s stop position defined by the two-dimensional codes C may accumulate and become larger. The present invention is particularly effective in such cases.

### When movement amount of transport vehicle during correction operation exceeds threshold value

The movement control unit B compares the movement amount of the transport vehicle 1A during the correction operation with the threshold value. If the movement amount exceeds the threshold value, the movement control unit B transmits information indicating that the movement amount exceeds the threshold value to a centralized management system in the ground side, for example, via a wireless communication device or similar equipment provided on the transport vehicle 1A. For example, after the movement control unit B stops the transport vehicle 1A and the position of the pallet W1 is manually corrected, the movement control unit B performs the correction operation. Alternatively, the movement control unit B may continue performing the correction operation without stopping the transport vehicle 1A, while the centralized management system issues instructions to other unmanned transport vehicles to avoid colliding with the transport vehicle 1A.

If the movement amount exceeds the threshold value, the movement control unit B may operate as follows without causing the transport vehicle 1A to transmit the information to the centralized management system in the ground side.

Specifically, the movement control unit B does not perform the correction operation, but causes the pallet W1 to be loaded on the transport vehicle 1A at a predetermined position where the pallet W1 is loaded on the transport vehicle 1A, then causes the transport vehicle 1A to move a predetermined distance in the opposite direction to a direction in which the transport vehicle moves for the correction operation, and to unload the pallet W1 from the transport vehicle 1A, and then performs the correction operation. As a result, even if the movement amount exceeds the threshold value, the correction operation can continue.

### Operation example when positional misalignment is detected during transport of transport object

During the transport of the pallet W1 as the transport object W by the unmanned transport vehicle, such as the transport vehicle 1A, the positional misalignment detection unit A may detect a positional misalignment of the pallet W1 relative to the transport vehicle 1A. At the time, the following actions are performed, for example.

(1) The transport vehicle 1A is stopped at a location where it can load the pallet W1, such as the inside of a rack.

(2) In the transport vehicle 1A, the lifting table 3 is moved downward to load the pallet W1 at the location.

(3) The movement control unit B performs the correction operation.

(4) The lifting table 3 is moved upward to lift the pallet W1 loaded at the location and to place the pallet W1 on the receiving sections 4.

(5) With the positional misalignment between the transport vehicle 1A and the pallet W1 eliminated, the transport vehicle 1A is caused to transport the pallet W1 to destination.

### Modified examples of unmanned transport vehicle and transport object

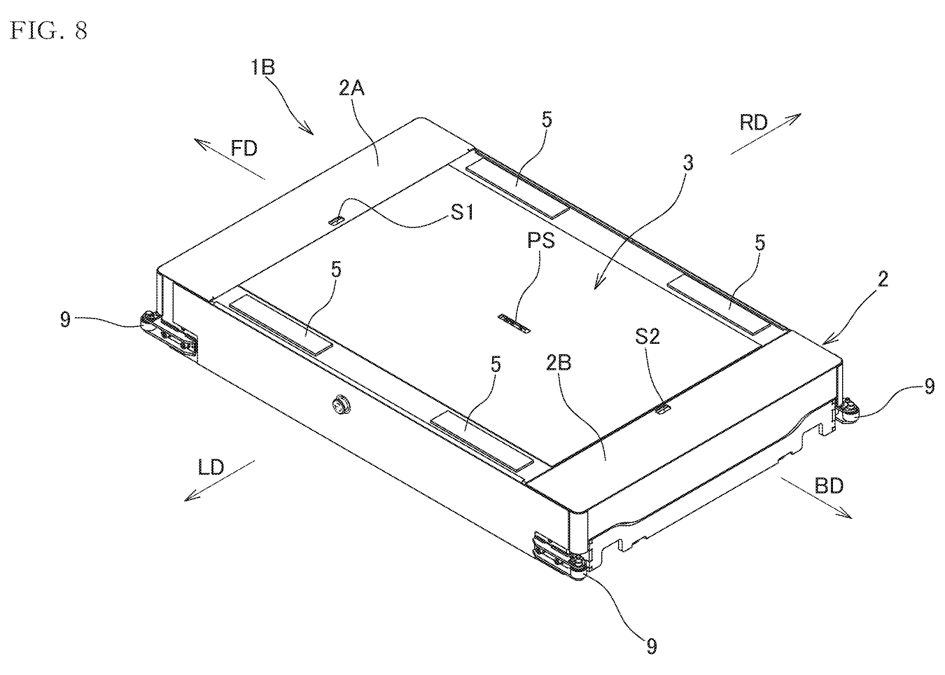

The transport vehicle 1B shown in FIGS. 8 and 9 is also an unmanned transport vehicle, similar to the transport vehicle 1A shown in FIGS. 1 to 3. In FIGS. 8 and 9, reference numerals identical to those in FIGS. 1 to 3 indicate identical or corresponding components or parts.

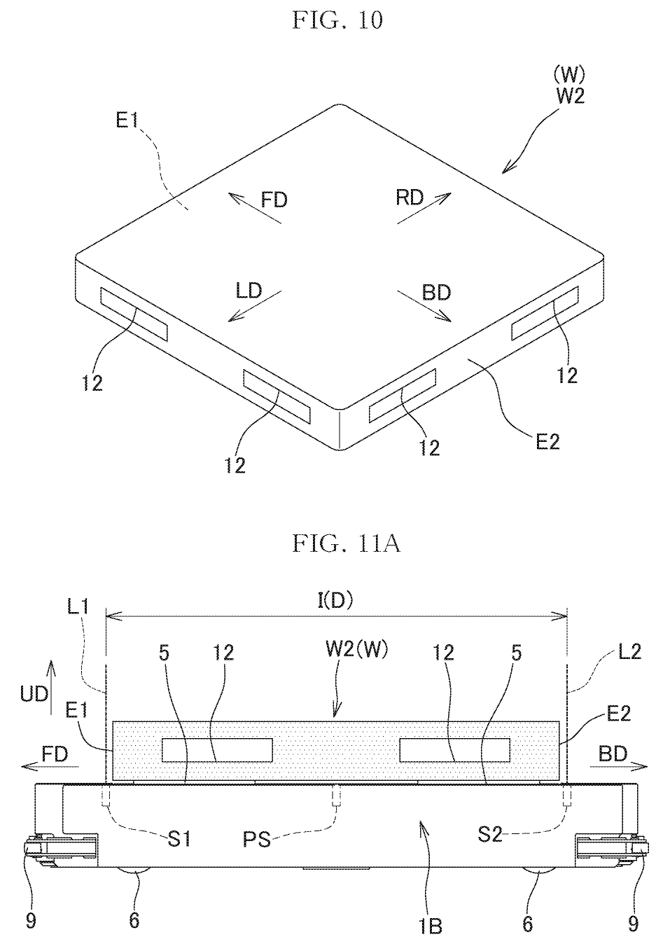

A flat pallet W2, which is the transport object W shown in FIG. 10, is placed on receiving sections 5 of the lifting table 3 shown in FIGS. 8 and 9. The flat pallet W2 has fork insertion slots 12 for receiving forks for a forklift. The transport vehicle 1B has a pallet detection sensor PS at the center of the lifting table 3 to detect presence or absence of the pallet W2.

### Detection of positional misalignment of pallet by positional misalignment detection unit

As shown in FIGS. 8 and 9, the positional misalignment detection unit A, which detects the positional misalignment of the pallet W2 relative to the transport vehicle 1B, includes a processing unit in the control device 10, as well as a pallet misalignment detection sensor S1 provided at a front end portion 2A of the vehicle body 2, and a pallet misalignment detection sensor S2 provided at a rear end portion 2B of the vehicle body 2.

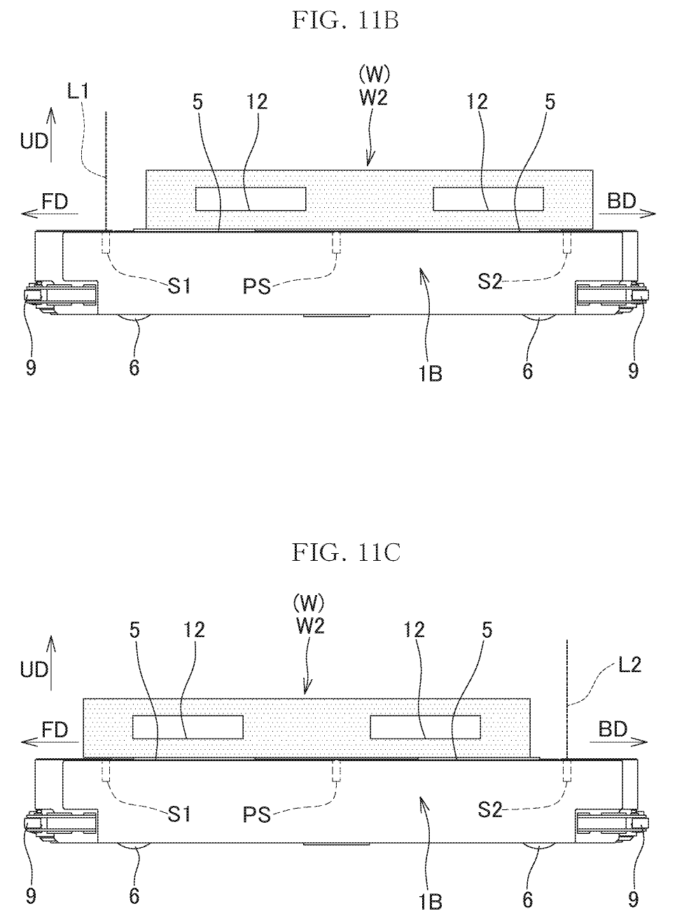

In the present embodiment, the positional misalignment detection unit A detects whether the pallet W2 is positionally misaligned based on whether the two light beams L1 and L2 pass through (whether the reflection occurs within the predetermined distance range), as shown in FIGS. 11A to11C.

The light beam L1 is emitted in an upward direction UD from the sensor S1 toward the pallet W2. The light beam L2 is emitted in the upward direction UD from the sensor S2 positioned in the backward direction BD side of the sensor S1, toward the pallet W2. The light beams L1 and L2 travel in parallel at a predetermined interval D (interval I in the front-back direction), as shown in FIG. 11A, for example.

As shown in FIG. 11A, when the pallet W2 is not positionally misaligned relative to the transport vehicle 1B, the pallet detection sensor PS detects the pallet W2. The positional relationship between the light beams L1 and L2 emitted from the pallet misalignment detection sensors S1 and S2 and the pallet W2 is as follows. Specifically, the light beam L1 travels through the forward direction FD side of the pallet W2, and the light beam L2 travels through the backward direction BD side of the pallet W2 (both sensors S1 and S2 detect no reflection within the predetermined distance range).

As shown in FIG. 11B, when the pallet W2 is positionally misaligned in the backward direction BD relative to the transport vehicle 1B, the light beam L1 travels through the frontward direction FD side of the pallet W2, and the light beam L2 is reflected on the pallet W2 (the sensor S1 does not detect the reflection within the predetermined distance range, while the sensor S2 detects the reflection within the predetermined distance range).

As shown in FIG. 11C, when the pallet W2 is positionally misaligned in the forward direction FD relative to the transport vehicle 1B, the light beam L1 reflects on the pallet W2, and the light beam L2 travels through the backward direction BD side of the pallet W2 (the sensor S1 detects the reflection within the predetermined distance range, while the sensor S2 does not detect the reflection within the predetermined distance range).

Accordingly, when either of the pallet misalignment detection sensors S1 and S2 detects the reflection within the predetermined distance range, the positional misalignment detection unit A determines that the pallet W2 is positionally misaligned relative to the transport vehicle 1B.

### Correction of positional misalignment of pallet by movement control unit

When the positional misalignment detection unit A detects the positional misalignment of the pallet W2, the movement control unit B controls the correction operation in the transport vehicle 1B that is to be moved for compensating the positional misalignment of the pallet W2.

In the case shown in FIG. 11B (the sensor S1 does not detect the reflection within the predetermined distance range, while the sensor S2 detects the reflection within the predetermined distance range), the pallet W2 is positionally misaligned in the backward direction BD relative to the transport vehicle 1B. Therefore, a direction in which the movement control unit B causes the transport vehicle 1B to move is the backward direction BD.

In the case shown in FIG. 11C (the sensor S1 detects the reflection within the predetermined distance range, while the sensor S2 does not detect the reflection within the predetermined distance range), the pallet W2 is positionally misaligned in the forward direction FD relative to the transport vehicle 1B. Therefore, a direction in which the movement control unit B causes the transport vehicle 1B to be moved is the forward direction FD.

The movement control unit B compares a movement amount of the transport vehicle 1B during the correction operation with a threshold value, when performing the correction operation.

As a result of the comparison by the movement control unit B between the movement amount and the threshold value, the movement amount may be below the threshold value, for example. In such a case, the correction operation enables correction of the positional misalignment of the pallet W2 relative to the transport vehicle 1B by the movement control unit B, and prevents interference with external objects during the correction operation.

FIGS. 11A to 11C show an example of detecting the positional misalignment of the pallet W2 using the positional misalignment detection unit A (pallet misalignment detection sensors S1, S2, etc.) in a state where the pallet W2 is placed on the receiving sections 5 of the lifting table 3 of the transport vehicle 1B. As another example, the positional misalignment of the pallet W2 may be detected by the positional misalignment detection unit A of the transport vehicle 1B that has slid beneath the pallet W2 with the pallet W2 placed on placement sections (not shown). In such a case, the correction operation is performed with the pallet W2 placed on the placement sections.

### Primary effect obtained by positional misalignment detection unit

According to the positional misalignment detection unit A of the above embodiments, it is possible to detect the presence or absence of the positional misalignment of the transport object W and a direction of the positional misalignment of the transport object W without providing a mark on the transport object W, and without incurring computational costs.

### Enhancement of accuracy in positional alignment of unmanned transport vehicle and transport object

As shown in FIG. 5A, even when the pallet W1 slightly moves in the forward direction FD or backward direction BD from a state where there is no positional misalignment relative to the transport vehicle 1A, the light beams L1 and L2 are reflected on the legs 11 of the pallet W1 (both sensors S1 and S2 detect the reflection within a predetermined distance range).

Similarly, as shown in FIG. 11A, even when the pallet W2 slightly moves in the forward direction FD or the backward direction BD from a state where there is no positional misalignment relative to the transport vehicle 1B, the light beam L1 travels through the forward direction FD side of the pallet W2, and the light beam L2 travels through the backward direction BD side of the pallet W2 (both sensors S1 and S2 do not detect reflections within the predetermined distance range).

In view of the above, further enhancement of the accuracy in the positional alignment between the transport vehicle 1A, 1B and the transport object W will be considered for a case when the positional misalignment detection unit A determines that the transport object W is not positionally misaligned relative to the transport vehicle 1A or 1B.

The positions of a front end E1 and a rear end E2 of the leg 11, which is part of the pallet W1 shown in FIGS. 4 and 5A, are defined with respect to the pallet W1. Furthermore, the positions of a front end E1 and a rear end E2 of the pallet W2 shown in FIGS. 10 and 11A are defined with respect to the pallet W2.

When the positional misalignment detection unit A determines that the pallet W1 is not positionally misaligned relative to the transport vehicle 1A, the movement control unit B causes the transport vehicle 1A to move in the front-back direction, and then causes the transport vehicle 1A to stop at a position where the positional misalignment detection unit A has detected the positional misalignment, to detect the front end E1 and the rear end E2 of the leg 11 of the pallet W1. A center position of the pallet W1 in the front-back direction, which is obtained from the detected front end E1 and rear end E2, is used to align the transport vehicle 1A relative to the pallet W1. This operation enables more accurate positional alignment of the transport vehicle 1A relative to the pallet W1 in the front-back direction.

Similarly, when the positional misalignment detection unit A determines that the pallet W2 is not positionally misaligned relative to the transport vehicle 1B, the movement control unit B causes the transport vehicle 1B to move in the front-back direction, and then causes the transport vehicle 1B to stop at a position where the positional misalignment detection unit A has detected the positional misalignment, to detect the front end E1 and rear end E2 of the pallet W2. A center position of the pallet W2 in the front-back direction, which is obtained from the detected front end E1 and rear end E2, is used to align the transport vehicle 1B relative to the pallet W2. This operation enables more accurate positional alignment of the transport vehicle 1B relative to the pallet W2 in the front-back direction.

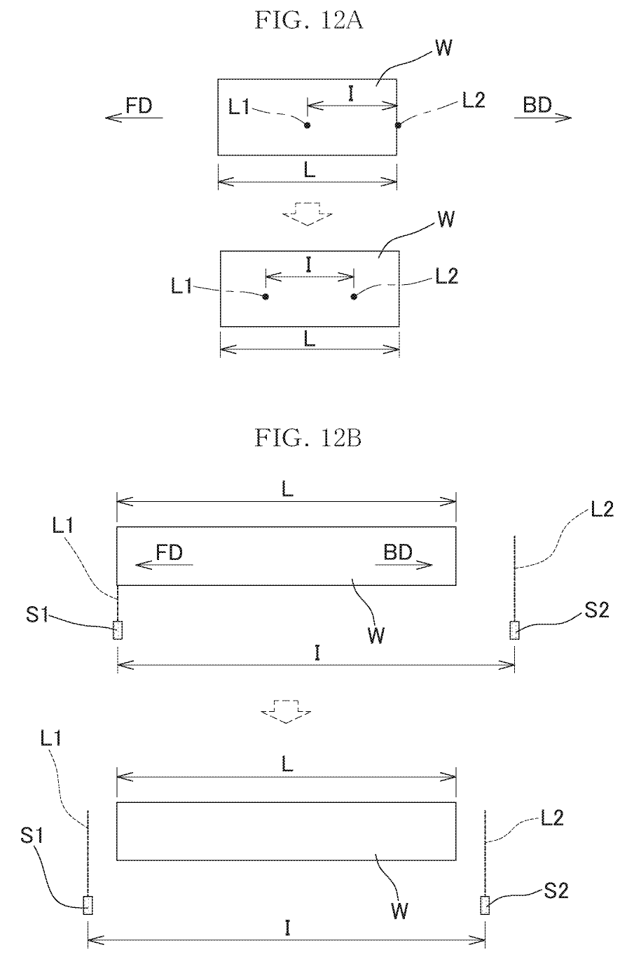

The schematic front views in FIGS. 12A and 12B will be referred to. FIG. 12A shows an example where length L of the transport object W in the front-back direction is greater than the interval I in the front-back direction between the two light beams L1 and L2. FIG. 12B shows an example where the length L of the transport object W in the front-back direction is shorter than the interval I in the front-back direction between the two light beams L1 and L2.

The upper diagram in FIG. 12A shows a state where the positional misalignment detection unit A has determined that the transport object W is not misaligned relative to the unmanned transport vehicle, and then the movement control unit B causes the unmanned transport vehicle to move in the backward direction BD, and then causes the unmanned transport vehicle to stop at a position where the positional misalignment detection unit A has detected the positional misalignment. The lower diagram in FIG. 12A shows a state the unmanned transport vehicle has been moved by [(L - I)/2] in the forward direction FD.

The upper diagram in FIG. 12B shows a state where the positional misalignment detection unit A determined that the transport object W is not positionally misaligned relative to the unmanned transport vehicle, and thus the movement control unit B causes the unmanned transport vehicle to move in the backward direction BD, and then causes the unmanned transport vehicle to stop at a position where the positional misalignment detection unit A has detected the positional misalignment. The lower diagram in FIG. 12B shows a state where the unmanned transport vehicle has been moved by [(I - L)/2] in the forward direction FD.

From the state where the positional misalignment detection unit A determined that no positional misalignment existed, the movement control unit B causes the unmanned transport vehicle to move in the backward direction BD or the forward direction FD, then causes the unmanned transport vehicle to stop at the position where the positional misalignment detection unit A has detected the positional misalignment, and causes the unmanned transport vehicle to move by |L - I|/2 in the forward direction FD or in the backward direction. Such operations as shown in FIGS. 12A and 12B enable the positional alignment of the unmanned transport vehicle relative to the transport object W in the front-back direction, with higher accuracy.

### Support for variations of legged pallets

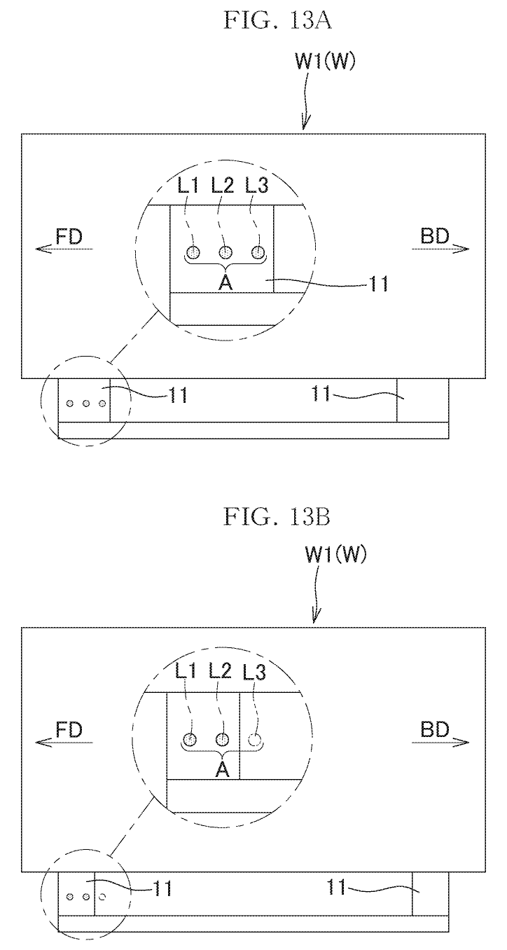

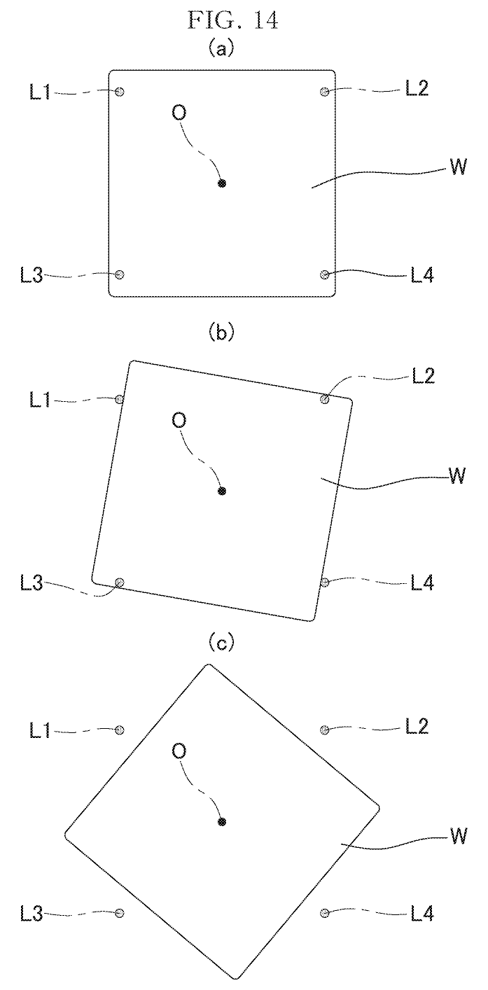

The schematic front views in FIGS. 13A and 13B show an example where three light beams spaced at predetermined intervals and traveling in parallel, are emitted from the unmanned transport vehicle toward the transport object W.

When each leg 11 is thick as in the case of the legged pallet W1 shown in FIG. 13A, and the three light beams L1, L2, L3 are reflected on the leg 11, the positional misalignment detection unit A determines that the legged pallet W1 is not positionally misaligned relative to the unmanned transport vehicle.

When each leg 11 is thin as in the case of the legged pallet W1 shown in FIG. 13B, and two of the three light beams L1, L2, L3, e.g., the light beams L1 and L2, reflect on the legs 11, the positional misalignment detection unit A determines that the legged pallet W1 is not positionally misaligned relative to the unmanned transport vehicle.

The light beams, which are emitted from the unmanned transport vehicle toward the transport object W and travel in parallel at predetermined intervals, may include three or more beams. Alternatively, two light beams may be emitted at variable intervals.

Three or more light beams, or two light beams with variable intervals may be emitted from the unmanned transport vehicle to the transport object W. In such a case, if the variation of a specified interval (front-back direction) in a surface of the transport object W, which receives the light beams, is increased, a positional misalignment detection unit A with the same configuration can address the variations.

### Detection of misalignment of transport object in rotational direction

The schematic plan view in FIG. 14 will be referred to. For example, the positional misalignment detection unit A of an unmanned transport vehicle (not shown) positioned below the transport object W, which is approximately rectangular in plan view, emits four light beams L1, L2, L3, and L4 upward. The positional misalignment detection unit A emits four light beams L1, L2, L3, and L4 from below toward, for example, the vicinity of four corners of the transport object W that is approximately rectangular in plan view and detects reflections within the predetermined distance range.

With this configuration, when there is no rotational misalignment around a vertical axis O of the transport object W as shown in (a) of FIG. 14, and then the rotational misalignment occurs as shown in (b) of FIG. 14, the reflection of light beams L1 and L4 ceases. When the rotational misalignment further increases from the state shown in (b) of FIG. 14 to a state shown in (c) of FIG. 14, the reflection of light beams L2 and L3 also ceases.

As described above, the positional misalignment detection unit A, which emits the four light beams L1, L2, L3, and L4, can detect the direction and magnitude of the rotational misalignment of the transport object W. Therefore, as described above, the movement control unit B of the unmanned transport vehicle, which can rotate on the spot, can correct the rotational misalignment.

The above descriptions of embodiments are all illustrative, and the present invention is not limited thereto. Various improvements and modifications may be made without departing from the scope of the present invention.

What is claimed is:

1. An unmanned transport vehicle that autonomously travels along a predetermined travel route to transport a transport object, the unmanned transport vehicle comprising:
a positional misalignment detection unit that detects positional misalignment of the transport object relative to the unmanned transport vehicle either before the transport object is loaded on the unmanned transport vehicle or while the transport object is loaded on the unmanned transport vehicle; and
a movement control unit that controls movement of the unmanned transport vehicle, wherein
the positional misalignment detection unit detects presence or absence of the positional misalignment by reflection or passing of at least two light beams that are emitted from the unmanned transport vehicle toward the transport object and travel in parallel at a predetermined interval, and
the movement control unit controls a correction operation of the unmanned transport vehicle that is to be moved for correcting the positional misalignment when the positional misalignment detection unit detects the positional misalignment, and compares an amount of the movement of the unmanned transport vehicle during the correction operation with a threshold value.

2. The unmanned transport vehicle according to claim 1, further comprising:
a two-dimensional code reading sensor that reads a two-dimensional code provided on a ground wherein
the two-dimensional code is read using the two-dimensional code reading sensor, thereby obtaining the amount of the movement.

3. The unmanned transport vehicle according to claim 1, wherein
two of the light beams are emitted under a condition where (i) a movement direction along which the unmanned transport vehicle approaches a predetermined position at which the transport object is loaded is defined as a forward direction, (ii) the predetermined interval is an interval in a front-back direction, and (iii) the light beams are emitted in a leftward direction or a rightward direction, and
the positional misalignment detection unit determines that no positional misalignment exists when detecting reflection of both the two light beams emitted in the leftward direction or the rightward direction.

4. The unmanned transport vehicle according to claim 1, wherein
two of the light beams are emitted under a condition where (i) a movement direction along which the unmanned transport vehicle approaches a predetermined position at which the transport object is loaded is defined as a forward direction, (ii) the predetermined interval is an interval in a front-back direction, and (iii) the light beams are emitted in an upward direction, and
the positional misalignment detection unit determines that no positional misalignment exists when detecting no reflection from either of the two light beams emitted in the upward direction.

5. The unmanned transport vehicle according to claim 3, wherein
when the positional misalignment detection unit determines that no positional misalignment exists,
the movement control unit
causes the unmanned transport vehicle to move in the front-back direction,
stops the unmanned transport vehicle at a position where the positional misalignment detection unit has detected the positional misalignment, and detects a front end and a rear end of an entire or a part of the transport object, and
uses a center position of the transport object in the front-back direction, to align the unmanned transport vehicle relative to the transport object, the center position being obtained from the front end detected and the rear end detected.

6. The unmanned transport vehicle according to claim 4, wherein
when the positional misalignment detection unit determines that no positional misalignment exists,
the movement control unit
causes the unmanned transport vehicle to move in the front-back direction,
stops the unmanned transport vehicle at a position where the positional misalignment detection unit has detected the positional misalignment, and detects a front end and a rear end of an entire or a part of the transport object, and
uses a center position of the transport object in the front-back direction, to align the unmanned transport vehicle relative to the transport object, the center position being obtained from the front end detected and the rear end detected.

7. The unmanned transport vehicle according to claim 3, wherein
when length of the transport object in the front-back direction is L, and an interval between the two light beams in the front-back direction is I,
from a state where the positional misalignment detection unit determined that no positional misalignment exists,
the movement control unit
causes the unmanned transport vehicle to move in one of the forward direction and the backward direction,
stops the unmanned transport vehicle at a position where the positional misalignment detection unit has detected the positional misalignment, and
causes the unmanned transport vehicle to move in a remaining one of the forward direction and the backward direction by |L - I|/2.

8. The unmanned transport vehicle according to claim 4, wherein
when length of the transport object in the front-back direction is L, and an interval between the two light beams in the front-back direction is I,
from a state where the positional misalignment detection unit determined that no positional misalignment exists,
the movement control unit
causes the unmanned transport vehicle to move in one of the forward direction and the backward direction,
stops the unmanned transport vehicle at a position where the positional misalignment detection unit has detected the positional misalignment, and
causes the unmanned transport vehicle to move in a remaining one of the forward direction and the backward direction by |L - I|/2.

9. The unmanned transport vehicle according to claim 1, wherein
if the amount of the movement exceeds the threshold value,
the movement control unit
refrains from performing the correction operation,
loads the transport object on the unmanned transport vehicle at a predetermined position where the unmanned transport vehicle loads the transport object, and
causes the unmanned transport vehicle to move by a predetermined distance in an opposite direction to a movement direction of the unmanned transport vehicle for performing the correction operation, unloads the transport object from the unmanned transport vehicle, and performs the correction operation.

10. The unmanned transport vehicle according to claim 1, wherein
the light beams emitted from the unmanned transport vehicle toward the transport object are three or more in number, or two in number with a variable interval between the two light beams.

11. The unmanned transport vehicle according to claim 1, wherein
the unmanned transport vehicle travels along a storage lane for the transport object and a path perpendicular to the storage lane, and refrains from entering the path when the correction operation is performed by the movement control unit.

12. The unmanned transport vehicle according to claim 7, wherein
the unmanned transport vehicle travels along a storage lane for the transport object and a path perpendicular to the storage lane, and refrains from entering the path when the correction operation is performed by the movement control unit.
